(19) United States
(12) Patent Application Publication
(10) Pub. No.: US 2013/0236765 A1
(43) Pub. Date: Sep. 12, 2013

(54) POLYMER LI-ION BATTERY AND THE SEPARATOR THEREOF

(71) Applicants: NINGDE AMPEREX TECHNOLOGY LIMITED, Ningde City (CN); DONGGUAN AMPEREX TECHNOLOGY LIMITED, Dongguan (CN)

(72) Inventors: Shengwu ZHANG, Ningde City (CN); Xinghua TAO, Ningde City (CN); Dewen ZHOU, Ningde City (CN); Rui XU, Ningde City (CN); Baiqing ZHANG, Ningde City (CN)

(73) Assignees: DONGGUAN AMPEREX TECHNOLOGY LIMITED, Dongguan (CN); NINGDE AMPEREX TECHNOLOGY LIMITED, Ningde City (CN)

(21) Appl. No.: 13/784,953

(22) Filed: Mar. 5, 2013

(30) Foreign Application Priority Data
Mar. 6, 2012 (CN) 201210056127.6

(51) Int. Cl. H01M 2/16

(52) U.S. Cl. CPC H01M 2/1686
USPC 429/144

(57) ABSTRACT

The invention pertains to the technical field of a polymer Li-ion battery, in particular to a polymer Li-ion battery separator, comprising porous substrate, wherein at least one surface of the porous substrate is coated with an inorganic coating and an organic coating; the organic coating, shaped like an island and/or linear distribution, is coated on the surface of the porous substrate and/or the inorganic matter coating.

### FIELD OF THE INVENTION

The invention pertains to the technical field of a polymer Li-ion battery, in particular to a polymer Li-ion battery and the separator thereof with good cycle performance, safety performance and mechanical properties.

### BACKGROUND OF THE INVENTION

The Li-ion battery has the advantages of higher mass energy density, higher volume energy density, higher working voltage, wider operating temperature, longer service life and environmental friendliness etc. Due to these advantages, the Li-ion battery is widely applied to mobile phones, notebook computers, all kinds of electric cars and even aerospace engineering as well as wind energy and solar energy storage devices.

Although the polymer Li-ion battery is widely used, it has potential safety hazard. So far, a plurality of accidents regarding explosion of mobile phone and laptop batteries have been reported in the newspapers, which triggers people to question safety performance of the Li-ion battery. The Li-ion battery separator serves as a key part for guaranteeing safety performance of the Li-ion battery. Especially under some special conditions, for example, high temperature baking, puncturing, overcharging or foreign material extruding etc., the separator is prone to damage. Short circuit in the battery can be resulted from shrinking, melting, oxidization or puncturing of the separator, which results in battery overheating, smoking or even exploding into flames and other accidents.

Usually, the polymer Li-ion battery is packaged in an aluminum plastic packing bag. As people are increasingly demanding for energy density of battery cells, a plurality of battery manufacturers gradually use negative electrode materials with high expansion ratio and improve winding process capability, which leads to particularly serious distortion of the battery; in addition, both safety and reliability of the battery can be badly affected.

On that account, it is indeed necessary to provide a polymer Li-ion battery separator with higher safety performance and mechanical properties so as to improve safety performance and cycle performance of the polymer Li-ion battery, to enhance stiffness of the battery cell and to reduce distortion of the Li-ion battery.

### SUMMARY OF THE INVENTION

One of the aims of the invention is, in view of disadvantages of the prior art, to provide a polymer Li-ion battery separator with higher safety performance and mechanical properties so as to improve safety performance and cycle performance of the polymer Li-ion battery, to enhance stiffness of the battery cell and to reduce distortion of the Li-ion battery.

In order to achieve the above-mentioned aim, the invention adopts such a technical scheme as below:

A polymer Li-ion battery separator comprise porous substrate, wherein at least one surface of the porous substrate is coated with an inorganic matter coating and an organic matter coating; the organic matter coating, shaped like an island and/or linear distribution, is coated on the surface of the porous substrate and/or the inorganic matter coating.

As an improvement of the polymer Li-ion battery separator, the inorganic matter coating has a thickness of 1 μm-50 μm.

As an improvement of the polymer Li-ion battery separator, the inorganic matter coating comprises inorganic particles and binders. The inorganic particles are at least one among aluminium oxide, silicon dioxide, titanium dioxide, zirconium dioxide, cerium oxide, calcium oxide, calcium carbonate and barium titanate; the adhesives are at least one among styrene-butadiene polymer, polyvinylidene fluoride, polyvinylpyrrolidone, vinylidene fluoride-hexafluoropropylene polymer, polyacrylonitrile, sodium carboxymethylcellulose, butadiene-acrylonitrile polymer, polyacrylic acid, polymethyl acrylate, ethyl acrylate and polyacrylic acid-styrene polymer.

As an improvement of the polymer Li-ion battery separator, the inorganic matter coating is coated on at least on surface of the porous substrate by dip-coating, gravure printing, silk-screen printing, spray coating or transfer coating processes.

As an improvement of the polymer Li-ion battery separator, the organic matter coating are at least one among polyvinylidene fluoride, polyvinylpyrrolidone, vinylidene fluoride-hexafluoropropylene polymer, polyacrylonitrile, sodium carboxymethylcellulose, sodium polyacrylate, butadiene-acrylonitrile polymer, ethyl acetate, polyacrylic acid, polymethyl acrylate, ethyl acrylate and polyacrylic acid-styrene polymer.

As an improvement of the polymer Li-ion battery separator, the island-shaped coating has an area of 0.1 μm-10 mm and a height of 1 μm-100 μm. As an improvement of the polymer Li-ion battery separator, the linear coating has a width of 0.1 μm-5 mm, a length of 1 μm-50 mm and a height of 1 μm-100 μm. As an improvement of the polymer Li-ion battery separator, area of the organic matter coating is 5-95% of that of the porous substrate.

As an improvement of the polymer Li-ion battery separator, the organic matter coating is coated on the porous substrate and/or the inorganic matter coating by dip-coating, gravure printing, silk-screen printing, spray coating, curtain coating transfer coating or slot-die coating.

Compared with the prior art, the polymer Li-ion battery separator at least has the advantages as below:

First, the inorganic matter coating in the separator makes the separator maintain higher thermal stability properties and mechanical properties, which is conducive to endowing the Li-ion battery with good safety performance; also the inorganic matter coating has good electrolyte absorbing capability, which endows the Li-ion battery with better cycle performance.

Second, the group of polymer in the organic matter coating in the separator has relatively powerful interaction with that of the electrolyte solvent, which endows the organic matter coating with good electrolyte absorbing and swelling capability; besides, effect of clamping force generated in the course of Li-ion battery processing makes the interface of the Li-ion battery maintain a good stability; meanwhile, the electrode in the Li-ion battery maintains an adequate cohesive force with the separator. Therefore, the Li-ion battery manufactured by this method has good mechanical properties.

Thirdly, distribution character of the organic matter coating in the separator provides space for electrode swelling during charge-discharge of cycle life, which successfully solves the problem of distortion of the polymer Li-ion battery, not affecting air permeability of the separator and ionic conductivity. Thus, the polymer Li-ion battery maintains an unchanged capacity and cycle performance.

The other aim of the invention is to provide a polymer Li-ion battery, which comprises a positive electrode, a negative electrode, a separator between the positive electrode and the negative electrode, and a certain amount of electrolyte, wherein the separator is any one polymer Li-ion battery separator of the claims mentioned above.

Compared with the prior art, the polymer Li-ion battery in the invention has higher safety performance and mechanical properties as well as higher hardness and smaller distortion.

### BRIEF DESCRIPTION OF THE DRAWINGS

FIG. 1 is a bend test curve obtained by making a comparison between the polymer Li-ion battery in Embodiment 4 and that in a comparison embodiment.

### DETAILED DESCRIPTION OF THE EMBODIMENTS

Further detailed description of the invention is made in conjunction with embodiments as below. However, mode of execution of the invention is not limited to these embodiments.

### The Comparison Embodiment

Preparation of the positive electrode:

Lithium cobaltate (a positive active material), superconductive carbon (a conductive additive, hereinafter to be referred as Super-P) and polyvinylidene fluoride (an adhesive, hereinafter to be referred as PVDF) are mixed uniformly by a mass ratio of 96:2.0:2.0 and made into slurry with a certain viscosity; the slurry is coated on a current collector aluminium foil, baked at a temperature of 85° C., cold pressed, side cut, sliced, stripped and then baked for 4 hours at a temperature of 85° C. under vacuum; then the positive electrode tab is welded. In this way, the positive electrode of the Li-ion battery is manufactured.

Preparation of the negative electrode:

Graphite, superconductive carbon (a conductive additive, hereinafter to be referred as Super-P), sodium carboxymethylcellulose (a thickening agent, hereinafter to be referred as CMC) and styrene butadiene rubber (an adhesive agent, hereinafter to be referred as SBR) are mixed uniformly by a mass ratio of 96.5:1.0:1.0:1.5 and made into slurry which is coated on a current collector copper foil, baked at a temperature of 85° C., side cut, sliced, stripped and then baked for 4 hours at a temperature of 110° C. under vacuum; then the negative electrode tab is welded. In this way, the negative electrode of the Li-ion battery is manufactured.

Preparation of the separator: a 20 um-thick three-layer microporous membrane made from polypropylene/polyethylene/polypropylene is used as the separator.

Preparation of the electrolyte: the electrolyte can be made by dissolving lithium hexafluorophosphate (LiPF₆) into a mixed solvent made up of ethylene carbonate (EC), dimethyl carbonate (DMC) and ethyl methyl carbonate (EMC) by a volume ratio of 1:2:1.

Preparation of the Li-ion battery: the positive electrode, the separator and the negative electrode are wound into a battery cell; the separator is positioned between the positive electrode and the negative electrode, the positive electrode is extracted by spot welding from the aluminium tab, and the negative electrode is extracted by spot welding from the nickel tab, then the battery cell is put into the aluminum plastic packing bag, and then the electrolyte is injected into the aluminum plastic packing bag, after processes of encapsulation, formation and capacity etc., the polymer Li-ion battery is manufactured in this way.

### Embodiment 1

Preparation of the positive electrode:

Lithium cobaltate (a positive active material), superconductive carbon (a conductive additive, hereinafter to be referred as Super-P) and polyvinylidene fluoride (an adhesive, hereinafter to be referred as PVDF) are mixed uniformly by a mass ratio of 96:2.0:2.0 and made into slurry with a certain viscosity; the slurry is coated on a current collector aluminium foil, baked at a temperature of 85° C., cold pressed, side cut, sliced, stripped and then baked for 4 hours at a temperature of 85° C. under vacuum; then the anode tab is welded. In this way, the positive electrode of the Li-ion battery is manufactured.

Preparation of the negative electrode:

Graphite, superconductive carbon (a conductive additive, hereinafter to be referred as Super-P), sodium carboxymethylcellulose (a thickening agent, hereinafter to be referred as CMC) and styrene butadiene rubber (an adhesive agent, hereinafter to be referred as SBR) are mixed uniformly by a mass ratio of 96.5:1.0:1.0:1.5 and made into slurry which is coated on a current collector copper foil, baked at a temperature of 85° C., side cut, sliced, stripped and then baked for 4 hours at a temperature of 110° C. under vacuum; then the cathode tab is welded. In this way, the negative electrode of the Li-ion battery is manufactured.

Preparation of the separator: a 16um-thick three-layer microporous membrane made from polypropylene/polyethylene/polypropylene is used as the porous substrate of the separator.

Manufacture instruction of inorganic matter coating slurry:

The inorganic slurry consists of: 32 shares of inorganic aluminium oxide nanopowder subject to surface modification, 8 shares of polyvinylpyrrolidone and 60 shares of N-Methyl pyrrolidone (hereinafter to be referred as NMP) solvent.

Preparation process:

First, polyvinylpyrrolidone and NMP (30 Kg in total) are put into a double planetary mixer with a capacity of 60 L for dispersing at a temperature 45° C. for 3 hours.

Second, 14.1 Kg aluminium oxide nanopowder is put into the double planetary mixer for high-speed dispersion at a temperature 45° C. for 2 hours, and then is subject to a ball-milling processing by a nanometer grinder for 1.5 hours; ball-shaped Zirmil with a diameter of 6 um is used as the grinding medium. In this way, the inorganic slurry can be made.

Preparation of the inorganic matter coating:

The porous substrate is surface coated via dip-coating, and a double-faced coating structure is formed, both faces of the coating have identical coating quality and thickness; the double-faced coating is baked via a three-section baking method (each section of a baking oven has a length of 3 m, and the baking temperature is set at 50° C., 60° C. and 60° C. respectively). The coating speed is controlled at 6m/min, the coated weight is controlled at 0.22 mg/cm², and the coating thickness on either face of the substrate is 10 um.

Manufacture instruction of organic matter coating slurry:

The organic coating slurry consists of: 15 shares of polyvinylidene fluoride (PVDF) powder, 40 shares of N-Methyl pyrrolidone (NMP) solvent and 45 shares of ethyl acetate.

Preparation process:

NMP and ethyl acetate (50 Kg in total) are put into the double planetary mixer with a capacity of 60 L for blending at a temperature 45° C. for 1 hour, and then 8.8 Kg PVDF powder is put into the double planetary mixer for dispersing and dissolving at a temperature 45° C. for 2 hours. In this way, the organic slurry is made.

Preparation of the organic matter coating:

The porous substrate (has been subject to surface treatment by the inorganic matter coating) is surface coated via gravure anilox roller coating, and a double-faced coating structure is formed, both faces of the coating have identical coating quality and thickness; the double-faced coating is baked via a three-section baking method (each section of a baking oven has a length of 3 m, and the baking temperature is set at 50° C., 60° C. and 60° C. respectively). The coating speed is controlled at 4 m/min, the coated weight is controlled at 0.13 mg/cm². Dried organic matter coating is distributed on the inorganic matter coating in the shape of an island and a line; the island-shaped coating has an area of 0.1 μm²-1 mm² and a height of 1 μm-50 μm, while the linear coating has a width of 0.1 μm-1 mm, a length of 1 μm-50 mm and a height of 1 μm-50 μm.

Preparation of the electrolyte: the electrolyte can be made by dissolving lithium hexafluorophosphate (LiPF6) into a mixed solvent made up of ethylene carbonate (EC), dimethyl carbonate (DMC) and ethyl methyl carbonate (EMC) by a volume ratio of 1:2:1.

Preparation of the Li-ion battery: the positive electrode, the separator and the negative electrode are wound into a battery cell; the separator is positioned between the positive electrode and the negative electrode, the positive electrode is extracted by spot welding from the aluminium tab, and the negative electrode is extracted by spot welding from the nickel tab, then the battery cell is put into the aluminum plastic packing bag, and then the electrolyte is injected into the aluminum plastic packing bag, after processes of encapsulation, formation and capacity etc., the polymer Li-ion battery is manufactured in this way.

### Embodiment 2

Embodiment 2 is different from Embodiment 1 in preparation of the separator.

A 16 um-thick polypropylene microporous membrane is used as the porous substrate of the separator.

Manufacture instruction of inorganic matter coating slurry:

The inorganic slurry consists of: 35 shares of inorganic silica dioxide nanopowder subject to surface modification, 10 shares of butadiene-acrylonitrile polymer and 55 shares of dimethyl carbonate solvent.

Preparation process:

First, butadiene-acrylonitrile polymer and dimethyl carbonate (30 Kg in total) are put into the double planetary mixer with a capacity of 60 L for dispersing at a temperature 45° C. for 3 hours.

Second, 16.1 Kg silica dioxide nanopowder is put into the double planetary mixer for high-speed dispersion at a temperature 45° C. for 2 hours, and then is subject to a ball-milling processing by a nanometer grinder for 1.5 hours; ball-shaped Zirmil with a diameter of 6 um is used as the grinding medium. In this way, the inorganic slurry can be made.

Preparation of the inorganic matter coating:

The porous substrate is surface coated via transfer coating, and a double-faced coating structure is formed, both faces of the coating have identical coating quality and thickness; the double-faced coating is baked via a three-section baking method (each section of a baking oven has a length of 3 m, and the baking temperature is set at 50° C., 60° C. and 60° C. respectively). The coating speed is controlled at 6 m/min, the coated weight is controlled at 0.23 mg/cm², and the coating on either face of the substrate is 1 um thick.

Manufacture instruction of organic matter coating slurry:

The organic slurry consists of: 12 shares of sodium polyacrylate powder, 50 shares of N-Methyl pyrrolidone (NMP) solvent and 38 shares of ethyl acetate.

Preparation process:

NMP and ethyl acetate (50 Kg in total) are put into the double planetary mixer with a capacity of 60 L for blending at a temperature 45° C. for 1 hour, and then 6.8 Kg sodium polyacrylate powder is put into the double planetary mixer for dispersing and dissolving at a temperature 45° C. for 2 hours. In this way, the organic slurry is made.

Preparation of the organic matter coating:

The porous substrate is surface coated via silk-screen printing twice at either face, and a double-faced coating structure is formed, both faces of the coating have identical coating quality and thickness; the double-faced coating is baked via a three-section baking method (each section of a baking oven has a length of 3 m, and the baking temperature is set at 50° C., 60° C. and 60° C. respectively). The coating speed is controlled at 4 m/min, the coated weight is controlled at 0.12 mg/cm². Dried organic matter coating is distributed on the inorganic matter coating and the porous substrate in the shape of an island and a line; the island-shaped coating has an area of 1 μm²-10 mm² and a height of 1 μm-10 μm, while the linear coating has a width of 1 μm-1 mm, a length of 1 μm-50 mm and a height of 1 μm-10 μm.

The remaining steps are the same as described in Embodiment 1, not repeated here.

### Embodiment 3

Embodiment 3 is different from Embodiment 1 in preparation of the separator.

A 16 um-thick polyethylene microporous membrane is used as the porous substrate of the separator.

Manufacture instruction of inorganic matter coating slurry:

The inorganic slurry consists of: 40 shares of mixture of titanium dioxide nanopowder and barium titanate micron powder (by a mass ratio of 1:1), 8 shares of mixture of fluoride-hexafluoropropylene polymer and polyacrylonitrile (by a mass ratio of 1:2) and 52 shares of cyclohexanone solvent.

Preparation process:

First, the mixture of fluoride-hexafluoropropylene polymer and polyacrylonitrile as well as cyclohexanone solvent (30 Kg in total) are put into the double planetary mixer with a capacity of 60 L for dispersing at a temperature 45° C. for 3 hours.

Second, 20 Kg mixture of titanium dioxide nanopowder and barium titanate micron powder is put into the double planetary mixer for high-speed dispersion at a temperature 45° C. for 2 hours, and then is subject to a ball-milling processing by a nanometer grinder for 1.5 hours; ball-shaped Zirmil with a diameter of 6 um is used as the grinding medium. In this way, the inorganic slurry can be made.

Preparation of the inorganic matter coating:

The porous substrate is surface coated via gravure printing twice at either face, and a double-faced coating structure is formed, both faces of the coating have identical coating quality and thickness; the double-faced coating is baked via a three-section baking method (each section of a baking oven has a length of 3 m, and the baking temperature is set at 50° C., 60° C. and 60° C. respectively). The coating speed is controlled at 6 m/min, the coated weight is controlled at 0.25 mg/cm², and the coating on either face of the substrate is 30 um thick.

Manufacture instruction of organic matter coating slurry:

The organic slurry consists of: 15 shares of polyacrylic acid-styrene polymer, 40 shares of trichloroethylene and 45 shares of ethanol.

Preparation process:

Trichloroethylene and ethanol (50 Kg in total) are put into the double planetary mixer with a capacity of 60 L for blending at a temperature 45° C. for 1 hour, and then 8.8 Kg polyacrylic acid-styrene polymer powder is put into the double planetary mixer for dispersing and dissolving at a temperature 45° C. for 2 hours. In this way, the organic slurry is made.

Preparation of the organic matter coating:

The porous substrate is surface coated via spray coating twice at either face, and a double-faced coating structure is formed, both faces of the coating have identical coating quality and thickness; the double-faced coating is baked via a three-section baking method (each section of a baking oven has a length of 3 m, and the baking temperature is set at 50° C., 60° C. and 60° C. respectively). The coating speed is controlled at 8 m/min, the coated weight is controlled at 0.13 mg/cm². Dried organic matter coating is distributed on the inorganic matter coating and the porous substrate in the shape of an island and a line; the island-shaped coating has an area of 1 μm²-10 mm² and a height of 1 μm-100 μm, while the linear coating has a width of 1 μm-1 mm, a length of 1 μm-50 mm and a height of 1 μm-100 μm.

The remaining steps are the same as described in Embodiment 1, not repeated here.

### Embodiment 4

Embodiment 4 is different from Embodiment 1 in preparation of the separator.

A 16 um-thick polypropylene microporous membrane is used as the porous substrate of the separator.

Manufacture instruction of inorganic matter coating slurry:

The inorganic slurry consists of: 32 shares of mixture of zirconium dioxide nanopowder and calcium carbonate micron powder (by a mass ratio of 1:2), 8 shares of mixture of sodium carboxymethylcellulose and polyacrylonitrile (by a mass ratio of 1:3) and 60 shares of N-Methyl pyrrolidone solvent.

Preparation process:

First, mixture of sodium carboxymethylcellulose and polyacrylonitrile as well as N-Methyl pyrrolidone solvent (30 Kg in total) are put into the double planetary mixer with a capacity of 60 L for dispersing at a temperature 45° C. for 3 hours.

Second, 14.1 Kg mixture of zirconium dioxide nanopowder and calcium carbonate micron powder is put into the double planetary mixer for high-speed dispersion at a temperature 45° C. for 2 hours, and then is subject to a ball-milling processing by a nanometer grinder for 1.5 hours; ball-shaped Zirmil with a diameter of 6 um is used as the grinding medium. In this way, the inorganic slurry can be made.

Preparation of the inorganic matter coating:

The porous substrate is surface coated via spray coating at one face, and a single-faced coating structure is formed; the single-faced coating is baked via a three-section baking method (each section of a baking oven has a length of 3 m, and the baking temperature is set at 50° C., 60° C. and 60° C. respectively). The coating speed is controlled at 6 m/min, the coated weight is controlled at 0.22 mg/cm², and the single-faced coating is 5 um thick.

Manufacture instruction of organic matter coating slurry:

The organic slurry consists of: 15 shares of mixed powder of polyacrylonitrile and vinylidene fluoride-hexafluoroethylene polymer (by a mass ratio of 1:5), 40 shares of N-Methyl pyrrolidone solvent and 45 shares of ethyl acetate.

Preparation process:

N-Methyl pyrrolidone and ethyl acetate solvents (50 Kg in total) are put into the double planetary mixer with a capacity of 60 L for blending at a temperature 45° C. for 1 hour, and then 8.8 Kg mixed powder of polyacrylonitrile and vinylidene fluoride-hexafluoroethylene polymer is put into the double planetary mixer for dispersing and dissolving at a temperature 45° C. for 2 hours. In this way, the organic slurry is made.

Preparation of the organic matter coating:

The porous substrate is surface coated via transfer coating, and a double-faced coating structure is formed, both faces of the coating have identical coating quality and thickness; the double-faced coating is baked via a three-section baking method (each section of a baking oven has a length of 3 m, and the baking temperature is set at 50° C., 60° C. and 60° C. respectively). The coating speed is controlled at 4 m/min, the coated weight is controlled at 0.13 mg/cm². Dried organic matter coating is distributed on the inorganic matter coating in the shape of an island and a line; the island-shaped coating has an area of 1 μm²-1 mm² and a height of 1 μm-10 μm, while the linear coating has a width of 1 μm-1 mm, a length of 1 μm-20 mm and a height of 1 μm-10 μm.

The remaining steps are the same as described in Embodiment 1, not repeated here.

### Embodiment 5

Embodiment 5 is different from Embodiment 1 in preparation of the separator.

A 20 um-thick polyethylene microporous membrane is used as the porous substrate of the separator.

Manufacture instruction of inorganic matter coating slurry:

The inorganic slurry consists of: 32 shares of cerium dioxide nanopowder, 8 shares of styrene-butadiene polymer and 60 shares of N-Methyl pyrrolidone solvent.

Preparation process:

First styrene-butadiene polymer and N-Methyl pyrrolidone solvent (30 Kg in total) are put into the double planetary mixer with a capacity of 60 L for dispersing at a temperature 45° C. for 3 hours.

Second, 14.1 Kg cerium dioxide nanopowder is put into the double planetary mixer for high-speed dispersion at a temperature 45° C. for 2 hours, and then is subject to a ball-milling processing by a nanometer grinder for 1.5 hours; ball-shaped Zirmil with a diameter of 6 um is used as the grinding medium. In this way, the inorganic slurry can be made.

Preparation of the inorganic matter coating:

The porous substrate is surface coated via silk-screen printing at one face, and a single-faced coating structure is formed; the single-faced coating is baked via a three-section baking method (each section of a baking oven has a length of 3 m, and the baking temperature is set at 50° C., 60° C. and 60° C. respectively). The coating speed is controlled at 6 m/min, the coated weight is controlled at 0.22 mg/cm², and the single-faced coating is 20 um thick.

Manufacture instruction of organic matter coating slurry:

The organic slurry consists of: 15 shares of sodium carboxymethylcellulose, 40 shares of N-Methyl pyrrolidone solvent and 45 shares of ethyl acetate solvent.

Preparation process:

N-Methyl pyrrolidone and ethyl acetate solvents (50 Kg in total) are put into the double planetary mixer with a capacity of 60 L for blending at a temperature 45° C. for 1 hour, and then 8.8 Kg sodium carboxymethylcellulose mixed powder is put into the double planetary mixer for dispersing and dissolving at a temperature 45° C. for 2 hours. In this way, the organic slurry is made.

Preparation of the organic matter coating:

The porous substrate is surface coated via transfer coating, and a double-faced coating structure is formed, both faces of the coating have identical coating quality and thickness; the double-faced coating is baked via a three-section baking method (each section of a baking oven has a length of 3 m, and the baking temperature is set at 50° C., 60° C. and 60° C. respectively). The coating speed is controlled at 4 m/min, the coated weight is controlled at 0.13 mg/cm². Dried organic matter coating is distributed on the inorganic matter coating in the shape of an island and a line; the island-shaped coating has an area of 1 μm²-1 mm² and a height of 1 μm-50 μm, while the linear coating has a width of 1 μm-1 mm, a length of 1 μm-50 mm and a height of 1 μm-50 μm.

The remaining steps are the same as described in Embodiment 1, not repeated here.

A porosity test, an air permeability test, a penetration resistance strength test and a thermal shrinkage test are respectively made for the separators in the comparison embodiment and Embodiments 1-5. In the thermal shrinkage test, the separators are put into a baking oven for baking at a temperature of 85° C. for 4 h, and the thermal shrinkage rate are calculated. The results are seen in Table 1 as below:

TABLE 1
performance tests regarding the separators in the comparison
embodiment and Embodiments 1-5

| | | | Penetration | |
|---|---|---|---|---|
| | | Thermal | resistance | Air |
| | Porosity | shrinkage rate | strength | permeability |
| Group | (%) | (85° C., 4 h, %) | (Kgf) | (100 cc, s) |
| Comparison | 35.6 | 4.2 | 0.233 | 350 |
| embodiment | | | | |
| Embodiment 1 | 35.9 | 0.5 | 0.291 | 365 |
| Embodiment 2 | 42.7 | 0.9 | 0.253 | 377 |
| Embodiment 3 | 35.0 | 0.2 | 0.304 | 358 |
| Embodiment 4 | 40.5 | 0.7 | 0.267 | 372 |
| Embodiment 5 | 35.5 | 0.3 | 0.289 | 361 |

From Table 1, the separators in the invention have higher penetration resistance strength and better high temperature thermal shrinkage resistance, from which we can know that, the polymer Li-ion battery adopting the separator in the invention has more excellent safety performance. In addition, both the porosity and the air permeability of the separators in the invention are unaffected by the inorganic matter coating and the organic matter coating. Consequently, the cycle performance of the polymer Li-ion battery is unaffected.

A cycle performance test and a high temperature storage test are respectively made for the polymer Li-ion batteries in the comparison embodiment and Embodiments 1-5.

In the cycle performance test: the polymer Li-ion battery is charged at a rate of 0.5 C at a temperature of 25° C. and then discharged at a rate of 0.5 C for 400 cycles successively, the capacity of the polymer Li-ion battery is measured under 0.5 C at room temperature and is compared with that of the polymer Li-ion battery at room temperature prior to the cycle performance test, and the capacity retention ratio of the polymer Li-ion battery is calculated after the cycle performance test by the following calculation formula: capacity retention ratio=(the capacity of the battery under 0.5 C/the capacity of the battery at room temperature prior to the cycle performance test)×100%.

The results are seen in Table 2.

The high temperature storage test: the Li-ion battery is stored for 30 days at 4.2V at a temperature of 60° C., the thickness of the Li-ion battery is recorded respectively before and after the storage, and the thickness swelling ratio of the Li-ion battery is calculated by the following calculation formula: the thickness swelling ratio=[(the difference value of the battery thickness after and before the storage)/the battery thickness before the storage]×100%.

The results are seen in Table 2.

TABLE 2
results of the cycle performance test and the high temperature storage
test of the polymer Li-ion batteries in the comparison embodiment and
Embodiments 1-5

| | Capacity retention | Thickness |
|---|---|---|
| Group | ratio (%) | swelling ratio (%) |
| Comparison | 85 | 25 |
| embodiment | | |
| Embodiment 1 | 88 | 5 |
| Embodiment 2 | 89 | 8 |
| Embodiment 3 | 86 | 2 |
| Embodiment 4 | 89 | 7 |
| Embodiment 5 | 87 | 4 |

From Table 2 we can know that, compared with the polymer Li-ion battery in the comparison embodiment, the polymer Li-ion battery in the invention is hardly affected in terms of the cycle performance and is much lower in terms of thickness swelling ratio, from which we can know that, distortion of the polymer Li-ion battery can be greatly reduced by the invention with the cycle performance of the battery unaffected.

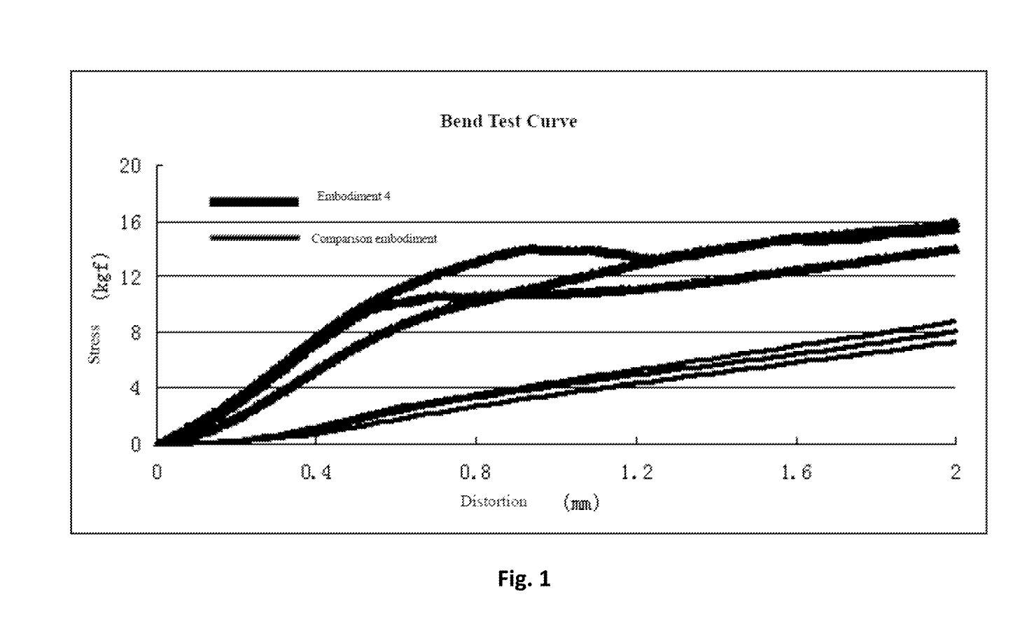

In addition, from FIG. 1 we can know that, compared with the separator of the comparison embodiment, the battery cell using the separator in the invention is subject to obviously smaller distortion under the same impact of external forces, which shows that the battery cell using the separator in the invention has higher mechanical strength.

It is necessary to state that, those skilled in the art can, on the basis of disclosure and elaboration of the specification above-mentioned, make a change or modification of the embodiments mentioned above. Therefore, the invention is not limited to the embodiments, and equivalent modification and change of the invention are within the scope of protection of claims of the invention. In addition, some specific terms are used in the specification for the convenience of description, but not to limit the invention.

What is claimed is:

1. A polymer Li-ion battery separator comprising porous substrate wherein at least one surface of the porous substrate is coated with an inorganic coating and an organic coating; the organic coating, shaped like an island and/or linear distribution, is coated on the surface of the porous substrate and/or the inorganic matter coating.

2. The polymer Li-ion battery separator of claim 1, wherein the inorganic matter coating has a thickness of 1 μm-50 μm.

3. The polymer Li-ion battery separator of claim 1, wherein the inorganic matter coating comprises inorganic particles and binders, the inorganic particles are at least one among aluminium oxide, silicon dioxide, titanium dioxide, zirconium dioxide, cerium oxide, calcium oxide, calcium carbonate and barium titanate; the binders are at least one among styrene-butadiene polymer, polyvinylidene fluoride, polyvinylpyrrolidone, vinylidene fluoride-hexafluoropropylene polymer, polyacrylonitrile, sodium carboxymethylcellulose, butadiene-acrylonitrile polymer, polyacrylic acid, polymethyl acrylate, ethyl acrylate and polyacrylic acid-styrene polymer.

4. The polymer Li-ion battery separator of claim 1, wherein the inorganic matter coating is coated on at least on surface of the porous substrate by dip-coating, gravure printing, silk-screen printing, spray coating or transfer coating.

5. The polymer Li-ion battery separator of claim 1, wherein the organic matter coating are at least one among polyvinylidene fluoride, polyvinylpyrrolidone, vinylidene fluoride-hexafluoropropylene polymer, polyacrylonitrile, sodium carboxymethylcellulose, sodium polyacrylate, butadiene-acrylonitrile polymer, ethyl acetate, polyacrylic acid, polymethyl acrylate, ethyl acrylate and polyacrylic acid-styrene polymer.

6. The polymer Li-ion battery separator of claim 1, wherein the island-shaped coating has an area of 0.1 μm-10 mm and a height of 1 μm-100 μm.

7. The polymer Li-ion battery separator of claim 1, wherein the linear coating has a width of 0.1 μm-5 mm, a length of 1 μm-50 mm and a height of 1 μm-100 μm.

8. The polymer Li-ion battery separator of claim 1, wherein area of the organic matter coating is 5-95% of that of the porous substrate.

9. The polymer Li-ion battery separator of claim 1, wherein the organic matter coating is coated on the porous substrate and/or the inorganic matter coating by dip-coating, gravure printing, silk-screen printing, spray coating, curtain coating transfer coating or slot-die coating.

10. A polymer Li-ion battery comprises a positive electrode, a negative electrode, a separator between the positive electrode and the negative electrode, and a certain amount of electrolyte, wherein the separator is the polymer Li-ion battery separator of claim 1.
